(19) United States
(12) Patent Application Publication
(10) Pub. No.: US 2015/0246840 A1
(43) Pub. Date: Sep. 3, 2015

(54) WORKPIECE CUTTING METHOD AND WORKPIECE CUTTING APPARATUS

(71) Applicant: IHI Corporation, Tokyo (JP)

(72) Inventors: Norihito KAWAGUCHI, Tokyo (JP); Junichi YAMADA, Tokyo (JP); Tomoo KUSUMI, Tokyo (JP); Toshiaki SAITO, Tokyo (JP)

(73) Assignee: IHI Corporation, Tokyo (JP)

(21) Appl. No.: 14/713,918

(22) Filed: May 15, 2015

Related U.S. Application Data
(63) Continuation of application No. PCT/JP2013/081064, filed on Nov. 18, 2013.

(30) Foreign Application Priority Data
Nov. 19, 2012 (JP) 2012-253024

(51) Int. Cl. C03B 33/09; B23K 26/14

(52) U.S. Cl. CPC C03B 33/091; B23K 26/14

(57) ABSTRACT

Provided is a workpiece cutting method of cutting a workpiece in which a reinforcement layer to which compression stress is applied is stacked on a surface of a non-reinforcement layer in a thickness direction of the workpiece, the workpiece cutting method including a process of continuously heating the surface of the reinforcement layer in a direction perpendicular to the thickness direction and transferring heat to the reinforcement layer and the non-reinforcement layer; and a process of injecting a cooling medium to a surface of the workpiece after heating, and generating thermal stress equal to or larger than breaking stress of the non-reinforcement layer in a boundary portion of the non-reinforcement layer with respect to the reinforcement layer. According to the workpiece cutting method, the workpiece can be rapidly cut, and deterioration of quality of the cutting portion can be suppressed.

This application is a continuation application based on a PCT Patent Application No. PCT/JP2013/081064, filed Nov. 18, 2013, whose priority is claimed on Japanese Patent Application No. 2012-253024, filed Nov. 19, 2012. The contents of both the PCT Application and the Japanese Application are incorporated herein by reference.

### TECHNICAL FIELD

In the related art, when plate-shaped glass serving as a workpiece is divided, a method of scribing a surface of the workpiece to form a groove as pre-processing and cutting the workpiece by concentrating stress on the groove through bending is known. In addition, in recent times, tempered glass in which a reinforcement layer having increased strength is formed by holding compression stress on a surface through chemical processing such as ion exchange or the like and strength is improved is distributed. Since a scratch cannot be easily generated on the reinforcement layer of the tempered glass, it is more difficult to perform the scribing on the tempered glass than on the glass in which the reinforcement layer is not formed.

Here, for example, in cutting processing disclosed in Patent Document 1, first, an initial crevice is formed at one end of the surface of the workpiece on which the reinforcement layer is formed by a cutter or the like. Then, as radiation of a laser beam and cooling by mist or the like are continuously performed using the initial crevice of the surface of the workpiece as a starting point, the crevice progresses in a surface direction of the surface of the workpiece along a trajectory of a laser beam radiation region from the initial crevice. In addition, in cutting processing disclosed in Patent Document 2, a groove to be cut is formed on the surface of the workpiece in which the reinforcement layer is formed by pre-dicing or the like, and the radiation of the laser beam and the cooling are performed with respect to the groove to be cut, thereby cutting the workpiece.

In this way, a direction of generating the crevice in the workpiece and cutting the workpiece along the crevice by continuously performing the radiation of the laser beam and the cooling with respect to the workpiece is also disclosed in Patent Documents 3 to 5.

### CITATION LIST

### Patent Document

### [Patent Document 1] Japanese Unexamined Patent Application, First Publication No. 2012-171810

### [Patent Document 2] Japanese Unexamined Patent Application, First Publication No. 2012-31018

### [Patent Document 3] Japanese Unexamined Patent Application, First Publication No. 2007-76077

### [Patent Document 4] Japanese Unexamined Patent Application, First Publication No. 2002-346782

### [Patent Document 5] Japanese Unexamined Patent Application, First Publication No. 2005-212364

### SUMMARY OF INVENTION

### Technical Problem

As disclosed in Patent Document 1 and Patent Document 2, when stress is mechanically applied to a workpiece using a cutter, dicing, or the like, to generate an initial crevice or a groove to be cut, since countless cracks are generated from the initial crevice or the groove to be cut, quality of the workpiece is deteriorated. Further, a tact time is increased to an extent of a machining time for generating the initial crevice and the groove to be cut in addition to the scribed groove.

In addition, in the cutting processing of the workpiece as a premise of the scribing of the related art including Patent Document 1 and Patent Document 2, in the cutting surface, a trajectory of the scribed groove may remain. In addition, after the scribed groove is generated, even when there is a need to perform bending on the workpiece, the tact time is increased.

An object of the present invention is to provide a workpiece cutting method and a workpiece cutting apparatus with which a workpiece can be rapidly cut and deterioration of quality of a cutting portion can be suppressed.

### Solution to Problem

In order to solve the problems, according to a first aspect of the present invention, a workpiece cutting method of cutting a workpiece is provided in which a reinforcement layer to which compression stress is applied is stacked on a surface of a non-reinforcement layer in a thickness direction of the workpiece, the workpiece cutting method including: a process of continuously heating the surface of the reinforcement layer in a direction perpendicular to the thickness direction and transferring heat to the reinforcement layer and the non-reinforcement layer; and a process of injecting a cooling medium to a surface of the workpiece after heating, and generating thermal stress equal to or larger than the breaking stress of the non-reinforcement layer in a boundary portion of the non-reinforcement layer with respect to the reinforcement layer.

In addition, in order to solve the problems, according to a second aspect of the present invention, a workpiece cutting method of cutting a workpiece is provided in which a reinforcement layer to which compression stress is applied is stacked on a surface of a non-reinforcement layer in a thickness direction of the workpiece, the workpiece cutting method including: a process of continuously heating the surface of the reinforcement layer in a direction perpendicular to the thickness direction and transferring heat to the reinforcement layer and the non-reinforcement layer; and a process of injecting a cooling medium to a surface of the workpiece after heating, and generating a crevice in the thickness direction in a boundary portion of the non-reinforcement layer with respect to the reinforcement layer.

In addition, in order to solve the problems, according to a third aspect of the present invention, a workpiece cutting method of cutting a workpiece is provided in which a reinforcement layer to which compression stress is applied is stacked on a surface of a non-reinforcement layer in a thickness direction of the workpiece, the workpiece cutting method including: a process of continuously heating the surface of the reinforcement layer in a direction perpendicular to the thickness direction and transferring heat to the reinforcement layer and the non-reinforcement layer; a process of injecting a cooling medium to a surface of the workpiece after heating; and a process of generating a crevice in the workpiece from a termination position to a starting position of heating the surface of the reinforcement layer and the process of injecting the cooling medium to the surface of the workpiece after heating after termination of these processes.

In the first to third aspects, in the process of heating the surface of the reinforcement layer, the starting position and the termination position of the heating processing may become boundaries between the surface and a side surface of the workpiece.

Further, in the process of heating the surface of the reinforcement layer, the workpiece may be linearly heated from the starting position to the termination position.

In addition, in the first to third aspects, in the process of heating the surface of the reinforcement layer, a laser beam may be radiated to heat the surface.

In this case, the laser beam may be generated using carbon dioxide gas as a medium.

Further, in the process of heating the surface of the reinforcement layer, the laser beam may be radiated a plurality of times to the same place of the surface of the workpiece. In this case, the laser beam radiated earlier may have higher energy per unit area upon arrival at the surface of the workpiece than the laser beam radiated later.

In addition, in the first to third aspects, the method may further include a process of supporting the workpiece with a uniform pressure from a back surface of the workpiece, before the process of heating the surface of the reinforcement layer.

In addition, in order to solve the problems, according to a fourth aspect of the present invention, a workpiece cutting apparatus for cutting a workpiece is provided in which a reinforcement layer to which compression stress is applied is stacked on a surface of a non-reinforcement layer in a thickness direction of the workpiece, the workpiece cutting apparatus including: a heating unit configured to continuously heat the surface of the reinforcement layer in a direction perpendicular to the thickness direction and transfer heat to the reinforcement layer and the non-reinforcement layer; and a cooling unit configured to inject a cooling medium to a surface of the workpiece after heating, and to generate thermal stress equal to or larger than breaking stress of the non-reinforcement layer in a boundary portion of the non-reinforcement layer with respect to the reinforcement layer.

In addition, in order to solve the problems, according to a fifth aspect of the present invention, a workpiece cutting apparatus for cutting a workpiece is provided in which a reinforcement layer to which compression stress is applied is stacked on a surface of a non-reinforcement layer in a thickness direction of the workpiece, the workpiece cutting apparatus including: a heating unit configured to continuously heat the surface of the reinforcement layer in a direction perpendicular to the thickness direction and transfer heat to the reinforcement layer and the non-reinforcement layer; and a cooling unit configured to inject a cooling medium to a surface of the workpiece after heating, wherein termination positions of the heating in the heating unit and the cooling in the cooling unit are determined to generate a crevice in the workpiece after termination of the heating and the cooling from the termination position toward starting positions of the heating and the cooling.

### Advantageous Effects of Invention

According to the present invention, the workpiece can be rapidly cut, and degradation of quality of the cutting portion can be suppressed.

### BRIEF DESCRIPTION OF DRAWINGS

FIG. 1 is a drawing for describing tempered glass serving as a workpiece;

FIG. 2 is a schematic perspective view of a workpiece cutting apparatus;

FIG. 3 is a flowchart for describing a flow of workpiece cutting processing;

FIG. 4A is a drawing for describing a principle according to which thermal stress is applied to the workpiece;

FIG. 4B is a drawing for describing the principle according to which the thermal stress is applied to the workpiece;

FIG. 4C is a drawing for describing the principle according to which the thermal stress is applied to the workpiece;

FIG. 4D is a drawing for describing the principle according to which the thermal stress is applied to the workpiece;

FIG. 5A is a drawing for describing a radiation region of a laser beam in the workpiece;

FIG. 5B is a drawing for describing the radiation region of the laser beam in the workpiece;

FIG. 6 is a graph showing an example of stress distribution applied to the workpiece;

FIG. 7A is a drawing for describing a progress direction of a crevice generated in the workpiece;

FIG. 7B is a drawing for describing the progress direction of the crevice generated in the workpiece;

FIG. 7C is a drawing for describing the progress direction of the crevice generated in the workpiece;

FIG. 8A is a drawing for describing a principle according to which permanent distortion is generated in a reinforcement layer;

FIG. 8B is a drawing for describing the principle according to which the permanent distortion is generated in the reinforcement layer;

FIG. 8C is a drawing for describing the principle according to which the permanent distortion is generated in the reinforcement layer;

FIG. 9 is a drawing showing an example of a shape of an end section of the workpiece;

FIG. 10A is a drawing for describing an example of a procedure of cutting the workpiece;

FIG. 10B is a drawing for describing an example of a procedure of cutting the workpiece;

FIG. 10C is a drawing for describing an example of a procedure of cutting the workpiece; and

FIG. 10D is a drawing for describing an example of a procedure of cutting the workpiece.

### DESCRIPTION OF EMBODIMENTS

Hereinafter, appropriate embodiments of the present invention will be described in detail with reference to the accompanying drawings. Dimensions, materials, and other specific values disclosed in the embodiment are merely provided for the convenience of understanding of the present invention, and do not limit the present invention unless the context clearly indicates otherwise. Further, in the specification and the drawings, elements having substantially the same functions and configurations are designated by the same reference numerals, and overlapping description thereof omitted, and illustration of elements not related to the present invention is omitted.

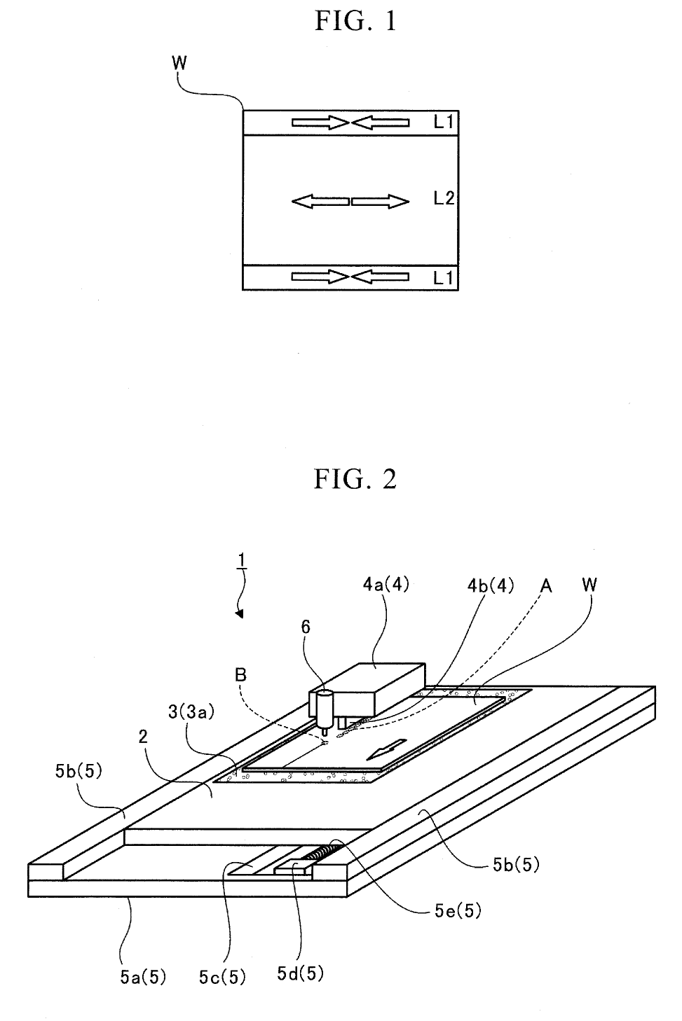

FIG. 1 is a drawing for describing a workpiece W of tempered glass, showing a cross-sectional view parallel to a thickness direction of the workpiece W. In the present embodiment, the workpiece W is constituted by, for example, a plate member (a base plate) of tempered glass, or the like.

Ion exchange processing of exchanging alkali ions in the glass with an alkali having a larger ion radius is performed on a surface of the workpiece W, and a reinforcement layer L1 onto which compression stress is applied is formed. That is, in the workpiece W, the reinforcement layer L1 onto which the compression stress is applied is stacked on a surface of a non-reinforcement layer L2. Here, in the workpiece W, a layer other than the reinforcement layer L1 is referred to as the non-reinforcement layer L2. The non-reinforcement layer L2 of the workpiece W is pulled to the neighboring reinforcement layer L1. As a result, tensile stress is applied to the non-reinforcement layer L2. Further, while a thickness of the workpiece W to which the present invention is applied is not particularly limited, the thickness of the reinforcement layer L1 may preferably be 15 μm or more, and more preferably 45 μm or more.

FIG. 2 is a schematic perspective view of a workpiece cutting apparatus 1. As shown in FIG. 2, the workpiece cutting apparatus 1 includes a base 2 on which the workpiece W is placed. A porous chuck 3 constituted by a porous body 3a and a suction unit (not shown) installed at a lower section of the porous body 3a is formed at the base 2, and the workpiece W is set on the porous chuck 3. The workpiece cutting apparatus 1 supports a back surface of the workpiece W with a uniform pressure by the porous chuck 3.

A laser radiation unit 4 (a heating unit) configured to radiate a laser beam toward the surface of the workpiece W supported by the base 2 is disposed immediately above the base 2. The laser radiation unit 4 includes an oscillator 4a and a head 4b. The oscillator 4a transits electrons of a medium into an excited state using an excitation source, and emission light generated when the electrons return to the ground state is resonated and amplified by a resonator. In the present embodiment, the laser beam generates carbon dioxide gas as a medium. The head 4b radiates the laser beam output from the oscillator 4a toward a radiation region A.

A conveyance unit 5 relatively moves the laser radiation unit 4 and the workpiece W. In an embodiment shown in FIG. 2, a position of the laser radiation unit 4 is fixed, and the workpiece W is moved along with the base 2 by the conveyance unit 5.

Specifically, the conveyance unit 5 includes a pedestal 5a. A pair of opposite rails 5b are disposed at the pedestal 5a, and the base 2 is installed between the rails 5b. Then, a motor 5d fixed in a space 5c formed at the pedestal 5a rotates a ball screw 5e extending in a moving direction of the rails 5b. A nut (not shown) fixed to a surface immediately under the base 2 is threadedly engaged with the ball screw 5e, the nut and the base 2 are moved in a direction in which the ball screw 5e extends according to rotation of the ball screw 5e.

An injection unit 6 (a cooling unit) is constituted by, for example, a mist injection apparatus provided in front of the laser radiation unit 4 in a conveyance direction of the workpiece W, and injects a cooling medium to the surface of the workpiece W to which the laser beam is radiated. For example, foggy (misty) water is used as the cooling medium.

A subject to which the injection unit 6 injects the cooling medium is an area (a cooling region B) of the workpiece W in front of the radiation region A of the laser beam in the conveyance direction (shown by a white arrow of FIG. 2) of the workpiece W. That is, the injection unit 6 injects the mist to an area of the workpiece W to which the laser is radiated by the laser radiation unit 4.

Further, here, while the case in which the position of the laser radiation unit 4 is fixed and the workpiece W is moved has been described, the position of the workpiece W may be fixed and the laser radiation unit 4 may be moved. In this case, the injection unit 6 may also be integrated with the laser radiation unit 4 and moved therewith. In any case, the conveyance unit 5 may relatively move the laser radiation unit 4 and the workpiece W, and the injection unit 6 may be provided in front of the laser radiation unit 4 in the moving direction of the workpiece W.

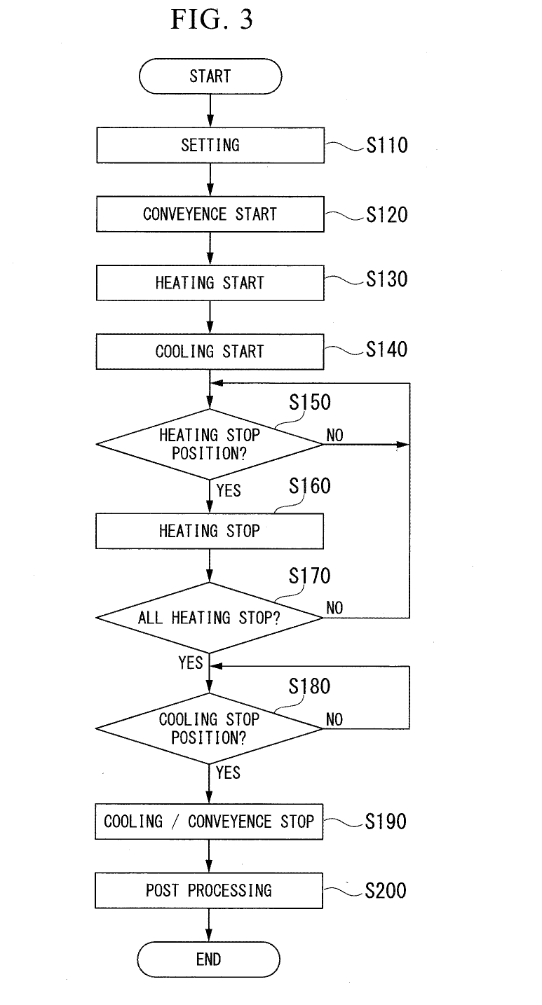

FIG. 3 is a flowchart for describing a flow of workpiece cutting processing. Hereinafter, a workpiece cutting method using the workpiece cutting apparatus 1 will be described in detail.

### (Setting Step S110)

First, the workpiece W is set on the porous chuck 3 disposed on the base 2 of the workpiece cutting apparatus 1, and suction by the porous chuck 3 is started. The workpiece W is supported by the porous chuck 3 at a uniform pressure from the back surface of the workpiece W.

### (Conveyance Starting Step S120)

Next, the conveyance unit 5 starts conveyance of the workpiece W, and relatively moves the laser radiation unit 4, the injection unit 6 and the workpiece W.

### (Heating Starting Step S130)

While the laser radiation unit 4 will be described below in detail, the laser radiation unit 4 can radiate laser beams to a plurality of places on the surface of the reinforcement layer L1 of the workpiece W. When the surface of the reinforcement layer L1 of the workpiece W arrives at a radiation position of the laser beam according to conveyance of the workpiece W, the laser radiation unit 4 starts radiation of the laser beam in sequence from the oscillator 4a at which the workpiece W arrives at the radiation position of the laser beam. The laser beam is absorbed by the surface of the reinforcement layer L1 of the workpiece W, and the surface of the reinforcement layer L1 of the workpiece W is heated.

In this way, the laser beam radiated from the laser radiation unit 4 scans the surface of the reinforcement layer L1 of the workpiece W in a direction (a surface direction) perpendicular to the thickness direction along the conveyance direction of the workpiece W. The laser radiation unit 4 transfers heat to the reinforcement layer L1 and the non-reinforcement layer L2 by continuously heating the reinforcement layer L1 in a surface direction thereof.

### (Cooling Starting Step S140)

The injection unit 6 injects the cooling medium to the surface of the workpiece W after heating. Like the laser radiation unit 4, since the position of the injection unit 6 is fixed, the cooling medium continuously cools the radiation portion of the laser beam in the surface of the reinforcement layer L1 of the workpiece W. Here, thermal stress is generated in the workpiece W.

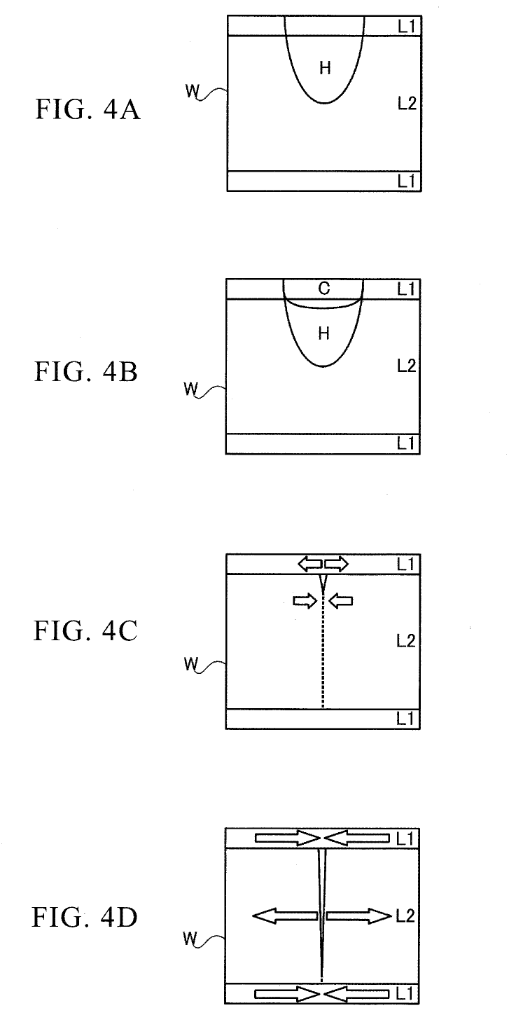

FIGS. 4A to 4D are drawings for describing a principle according to which thermal stress is applied to the workpiece W. As shown in FIG. 4A, when the radiation of the laser beam by the laser radiation unit 4 is performed, the surface of the reinforcement layer L1 of the workpiece W is heated (a high temperature zone H). Heat of the surface of the reinforcement layer L1 is transferred to the non-reinforcement layer L2 in the workpiece W.

Then, as shown in FIG. 4B, the cooling medium is injected to the surface of the reinforcement layer L1 of the workpiece W by the injection unit 6, and the surface of the reinforcement layer L1 of the workpiece W of the high temperature zone H is cooled (a low temperature zone C). While the high temperature zone H expands and the low temperature zone C contracts due to variation in temperature, deformation in the workpiece W is suppressed by a region having little variation in temperature around the high temperature zone H and the low temperature zone C. As a result, as shown by a white arrow of FIG. 4C, compression stress is generated in the high temperature zone H, and tensile stress is generated in the low temperature zone C.

Since the strength of the non-reinforcement layer L2 is relatively lower than that of the reinforcement layer L1, thermal stress generated in the reinforcement layer L1 and the non-reinforcement layer L2 according to existence of the high temperature zone H and the low temperature zone C exceeds breaking stress (breaking strength) of the non-reinforcement layer L2, and as a result, a crevice is generated in the non-reinforcement layer L2. That is, the thermal stress equal to or larger than the breaking stress of the non-reinforcement layer L2 is applied to a boundary portion of the non-reinforcement layer L2 with the reinforcement layer L1, and thus the crevice is generated.

Then, when a local difference in temperature is attenuated and the thermal stress disappears, as shown in FIG. 4D, since a force of the compression stress of the reinforcement layer L1 is received and the tensile stress is applied to the non-reinforcement layer L2, the crevice generated in the non-reinforcement layer L2 progresses in the thickness direction of the workpiece W, and the non-reinforcement layer L2 is cut.

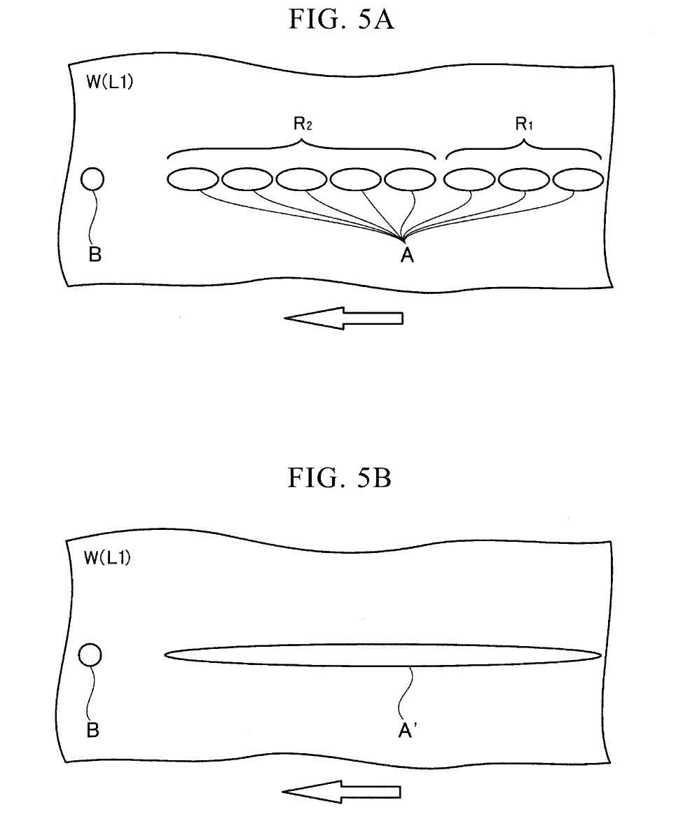

FIGS. 5A and 5B are drawings for describing the radiation region A of the laser beam in the workpiece W. While it is known that deterioration of quality of the cut workpiece W is suppressed as the conveyance speed of the workpiece W becomes a high speed, when the conveyance speed of the workpiece W is increased, a radiation time of the laser beam with respect to the workpiece W is reduced. Here, as shown in FIG. 5B, while extending a radiation region A′ of the laser beam in the conveyance direction of the workpiece W (in FIGS. 5A and 5B, a direction shown by a white arrow) to extend the radiation time may be considered, in that case, temperatures at both end sides of the radiation region cannot be easily increased.

Here, in the present embodiment, the laser radiation unit 4 has the plurality of oscillators 4a and the plurality of heads 4b. Then, as shown in FIG. 5A, the laser radiation unit 4 simultaneously radiates the laser beams with respect to a plurality of places on the surface of the reinforcement layer L1 of the workpiece W (the radiation region A).

Here, an alignment direction of the radiation region A of the laser beam in the workpiece W is parallel to the conveyance direction of the workpiece W by the conveyance unit 5. For this reason, when the conveyance unit 5 conveys the workpiece W, the laser beam is radiated to the same places on the surface of the reinforcement layer L1 of the workpiece W a plurality of times.

In the present embodiment, while the laser beam by the carbon dioxide gas in which energy becomes high output is used, since the laser beam is absorbed into the surface without passing through the glass, the heating portion becomes the surface of the reinforcement layer L1 of the workpiece W. In order to generate the thermal stress equal to or larger than the breaking stress in the boundary portion between the reinforcement layer L1 and the non-reinforcement layer L2, there is need to transfer heat of the surface to the boundary portion between the reinforcement layer L1 and the non-reinforcement layer L2. Then, in order to efficiently perform the heat transfer to the boundary portion, the surface of the reinforcement layer L1 may be rapidly heated to generate a large difference in temperature.

As described above, by radiating the laser beam a plurality of times, a radiation range of the laser beam can be narrowed, the energy per unit area provided upon arrival at the surface of the reinforcement layer L1 of the workpiece W can be increased, and the surface of the reinforcement layer L1 of the workpiece W can be locally and rapidly increased in temperature. For this reason, the heat can be easily transferred from the reinforcement layer L1 to the non-reinforcement layer L2, and the heating can be securely performed to a temperature required for cutting the non-reinforcement layer L2. Then, the thermal stress exceeding the breaking stress can be generated by cooling the reinforcement layer L1.

In addition, in the present embodiment, to the same place on the surface of the reinforcement layer L1 of the workpiece W, a laser beam radiated earlier has higher energy per unit area upon arrival at the surface of the reinforcement layer L1 of the workpiece W than a laser beam radiated later.

Specifically, in FIG. 5A, the radiation region A disposed at a relatively right side has higher energy per unit area of the laser beam upon arrival at the radiation region A than the radiation region A disposed at a relatively left side. Here, in the laser radiation unit 4, two kinds of the oscillators 4a having different outputs are prepared, in the three radiation regions A of the right side, a laser beam R1 is radiated by the oscillator 4a having relatively high output, and in the remaining five radiation regions A, a laser beam R2 is radiated by the oscillator 4a having relatively low output.

Further, while the output of the laser beam emitted from the laser radiation unit 4 depends upon the thickness or the material of the workpiece W, the stress distribution in the workpiece W, the conveyance speed of the workpiece W (a relative moving speed between the workpiece W and the laser radiation unit 4), and so on, for example, when the two kinds of oscillators 4a having different outputs are prepared, a sum of the outputs is about 180 watts.

In addition, as the convergence position of the laser beam is adjusted and the size of the radiation region A is reduced, the energy per unit area may be set such that the radiation region A disposed at the relatively right side of FIG. 5A is increased.

In this way, the surface of the reinforcement layer L1 is heated to a level at which a minimal thermal insulation can be maintained so as to rapidly increase temperature of the surface of the reinforcement layer L1 at an initial heating timing that has a large influence on the heat transfer toward the non-reinforcement layer L2 and then so as not to escape the heat transferred to the non-reinforcement layer L2. According to the above-mentioned configuration, energy consumption by the laser beam can be suppressed, and in the cooling processing, a decrease in temperature of the surface of the reinforcement layer L1 using the injection unit 6 can be rapidly performed.

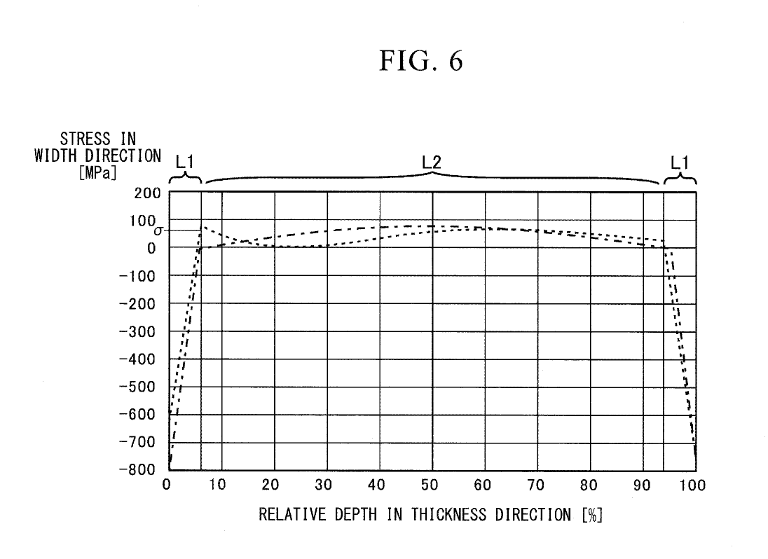

FIG. 6 is a graph showing stress distribution applied to the workpiece W. In FIG. 6, a horizontal axis represents a percentage of a depth from the surface of the reinforcement layer L1 of the workpiece W (a relative depth in a plate thickness direction of the workpiece W) with respect to the plate thickness of the workpiece W, and a vertical axis represents stress applied to the workpiece W in a width direction of the workpiece W (a direction parallel to the surface of the workpiece W and perpendicular to the conveyance direction of the workpiece W). Here, stress in a tensile direction is shown as a positive value, and stress in a compression direction is shown as a negative value. In addition, in FIG. 6, dotted lines represent initial stress before thermal stress is applied, and broken lines represent final internal stress after thermal stress is applied.

As shown in FIG. 6, in the initial stress, the compression stress is applied to the reinforcement layer L1, the tensile stress is applied to the non-reinforcement layer L2, and stress of the boundary portion between the reinforcement layer L1 and the non-reinforcement layer L2 becomes substantially 0.

Meanwhile, the final internal stress after the thermal stress is applied exceeds the breaking stress σ of the non-reinforcement layer L2 at the boundary portion between the reinforcement layer L1 and the non-reinforcement layer L2 of a left side of FIG. 6 at which the laser beam is radiated (a side of the surface of the workpiece W to which the laser beam is radiated). In this way, the non-reinforcement layer L2 is cut from the boundary portion with the reinforcement layer L1.

### (Heating Stoppage Determination Processing Step S150)

Returning to FIG. 3, it is determined whether or not any of the plurality of radiation regions A of the laser radiation unit 4 has arrived at the cutting termination position in the surface of the reinforcement layer L1 of the workpiece W. And then, when none has arrived (NO in S150), a heating stoppage determination processing step S150 is repeated, and when any one has arrived at the termination position (YES in S150), processing is shifted to a heating stoppage processing step S160.

### (Heating Stoppage Processing Step S160)

The laser radiation unit 4 stops the radiation of the laser beam in which the radiation region A has arrived at the termination position, and stops heating of the surface of the reinforcement layer L1 of the workpiece W.

### (Entire Heating Stoppage Determination Processing Step S170)

It is determined whether all the radiation of the laser beam by the laser radiation unit 4 has stopped, when the radiation has not stopped (NO in S170), processing is shifted to the heating stoppage determination processing step S150, and when all the radiation of the laser beam by the laser radiation unit 4 has stopped (YES in S170), processing is shifted to a cooling stoppage determination processing step S180.

### (Cooling Stoppage Determination Processing Step S180)

It is determined whether the cooling region B of the injection unit 6 has arrived at the cutting termination position (a rear end section in the conveyance direction of the workpiece W) in the surface of the reinforcement layer L1 of the workpiece W, when it has not arrived (NO in S180), a cooling stoppage determination processing step S180 is repeated, and when it has arrived (YES in S180), processing is shifted to a cooling/conveyance stoppage processing step S190.

### (Cooling/Conveyance Stoppage Processing Step S190)

The injection unit 6 stops injection of the cooling medium, the conveyance unit 5 stops conveyance of the workpiece W after conveyance of the workpiece W to a predetermined position, and processing is shifted to a post-processing step S200.

### (Post-Processing Step S200)

Suction by the porous chuck 3 is stopped, and the workpiece W is taken out of the workpiece cutting apparatus 1.

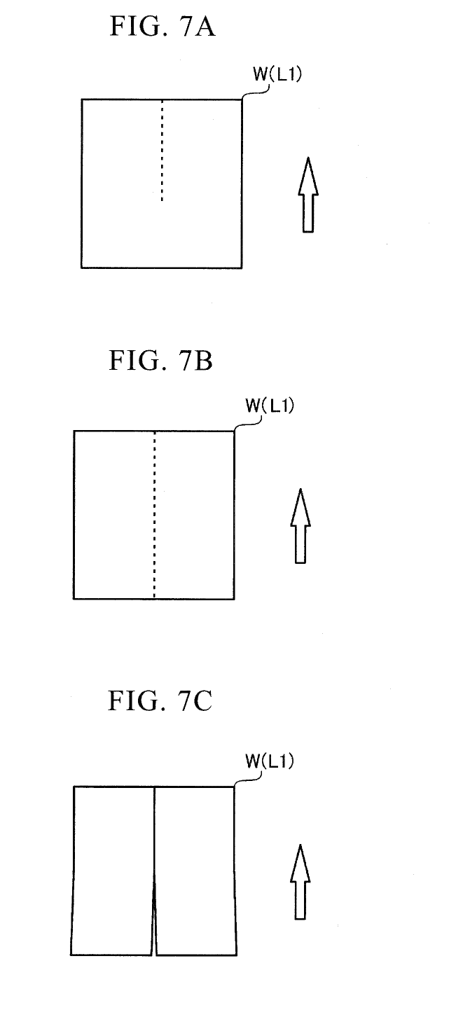

FIGS. 7A to 7C are drawings for describing a progress direction of a crevice of the workpiece W. As shown in FIG. 7A, according to the conveyance of the workpiece W, the crevice of the non-reinforcement layer L2 progresses in the conveyance direction (shown by white arrows in the drawings) along with progress in the thickness direction.

Then, the radiation region A and the cooling region B of the laser beam are moved from an upper end (a starting point) of the workpiece W to a lower end (a termination point) of FIGS. 7A to 7C by conveyance of the workpiece W, and as shown in FIG. 7B, the crevice of the non-reinforcement layer L2 progresses from the starting point to the termination point. Then, as shown in FIG. 7C, in the reinforcement layer L1, the crevice progresses in an opposite direction from the lower end (the termination point) to the upper end (the starting point). In this way, the workpiece W is automatically cut.

The inventor(s) of the application has experimentally found that when the heating processing and the cooling processing are stopped before arrival at the rear end section in the conveyance direction of the workpiece W, the crevice does not progress in the reinforcement layer L1, and the workpiece W is not cut.

In the process of heating and cooling the surface of the reinforcement layer L1 of the present embodiment (from above-mentioned step S130 to step S190), the starting position and the termination position of the heating processing and the cooling processing with respect to the workpiece W become boundaries between the surface and side surface(s) of the reinforcement layer L1 of the workpiece W (ends of the surface), i.e., both end sections of the workpiece W. According to the above-mentioned configuration, the crevice of the reinforcement layer L1 progresses from the end to the end, and the workpiece W can be reliably cut.

In addition, in the reinforcement layer L1, the reason for allowing the crevice to progress in the opposite direction from the termination point to the starting point is presumed as follows.

As a result of observation of the surface of the workpiece W after termination of the radiation and cooling of the laser beam, it is determined that the surface of the workpiece W is slightly raised in the radiation region A of the laser beam. This shows that permanent distortion is generated in the reinforcement layer L1 in the radiation region A of the laser beam.

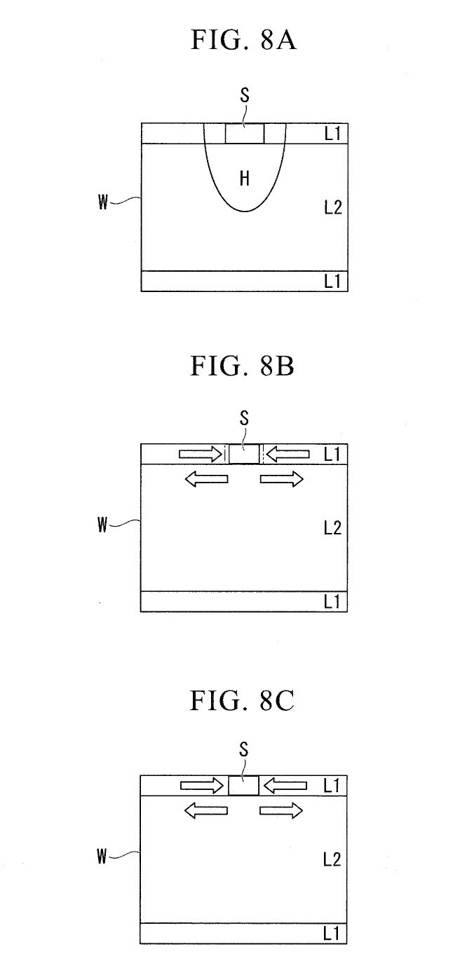

FIGS. 8A to 8C are drawings for describing a principle according to which permanent distortion is generated in the reinforcement layer L1. Further, in the drawings, white arrows represent the directions of the stress applied to the reinforcement layer L1 and the non-reinforcement layer L2.

As shown in FIG. 8A, when the laser beam is radiated to the workpiece W, the surface of the reinforcement layer L1 is heated and the high temperature zone H is formed in the reinforcement layer L1. In addition, accordingly, in the high temperature zone H, in a central region in the width direction of the workpiece W (a portion shown by reference character S of FIG. 8A, hereinafter referred to as a distorted section), the temperature exceeds a distortion point of the reinforcement layer L1, and fluidity of the reinforcement layer L1 is varied (softened). In addition, accordingly, the compression stress is decreased in the distorted section S.

Meanwhile, since the conventional compression stress is applied to the reinforcement layer L1 around the distorted section S, as shown in FIG. 8B, the distorted section S receives the compression stress from the reinforcement layer L1 therearound, and contracts in the width direction (see a variation from dotted lines to solid lines of FIG. 8B). In addition, accordingly, the distorted section S is slightly raised from the surface of the workpiece W. Meanwhile, tensile stress is applied to the non-reinforcement layer L2.

When the cooling medium is injected onto the surface of the workpiece W and the surface of the reinforcement layer L1 is cooled, as shown in FIG. 8C, contraction of the distorted section S is maintained. As a result, permanent distortion is generated in the distorted section S. In addition, since the tensile stress is applied to the non-reinforcement layer L2, distortion of the distorted section S is further increased. However, in this state, even when the crevice is generated in the non-reinforcement layer L2 as previously described with reference to FIG. 4D, the distortion accumulated in the distorted section S by these actions does not exceed the breaking strength of the distorted section S. Accordingly, no crevice is generated in the distorted section S.

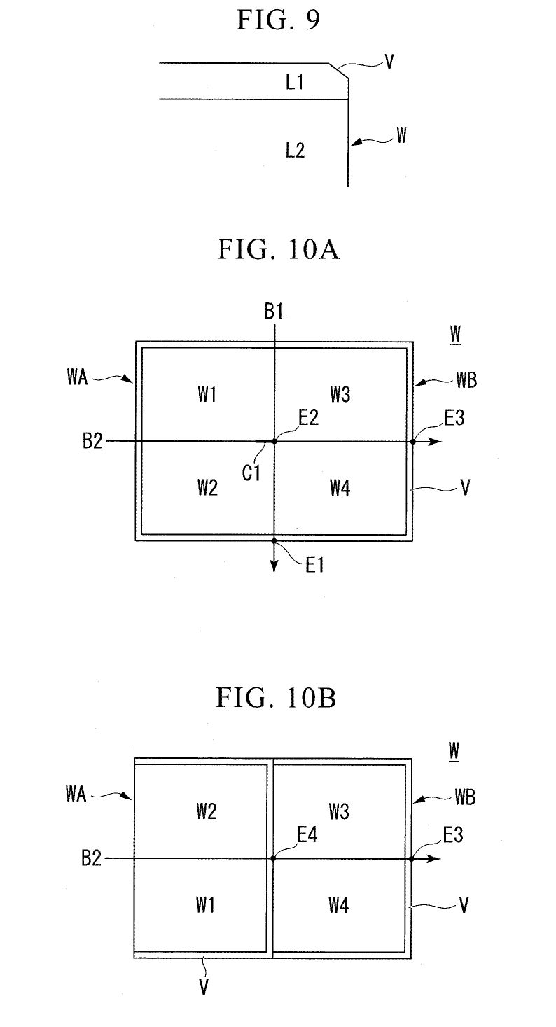

Here, an end section (a boundary between the surface and the side surface) of the tempered glass used as the workpiece W is chamfered as shown by reference character V of FIG. 9. That is, the reinforcement layer L1 is thinned in the end section of the workpiece W, and as a result, the breaking strength of the distorted section S formed at the end section of the workpiece W is also relatively decreased. Accordingly, when the radiation region A and the cooling region B of the laser beam are moved to the termination point (i.e., the end section of the workpiece W) as previously shown in FIG. 7B, in the end section of the workpiece W, the distortion accumulated in the distorted section S exceeds the breaking strength of the distorted section S, and the crevice is generated in the distorted section S.

Then, with the crevice as the starting point, the distortion accumulated in the distorted section S is released, the crevice progresses in the opposite direction from the termination point to the starting point in the reinforcement layer L1, and the workpiece W is automatically cut.

On the other hand, at the termination point of the radiation and cooling (hereinafter, referred to as cutting manipulation) of the laser beam with respect to the workpiece W, when the reinforcement layer L1 of the workpiece W is not thinned, the distortion accumulated in the distorted section S does not exceed the breaking strength of the distorted section S, and as a result, the workpiece W is not automatically cut. In this case, as the initial crevice is formed at the surface of the workpiece W, the reinforcement layer L1 at the termination point of the cutting manipulation is thinned.

In consideration of the above-mentioned matters, an example of cutting of the workpiece W to which the workpiece cutting method and the workpiece cutting apparatus according to the present embodiment are applied will be described below.

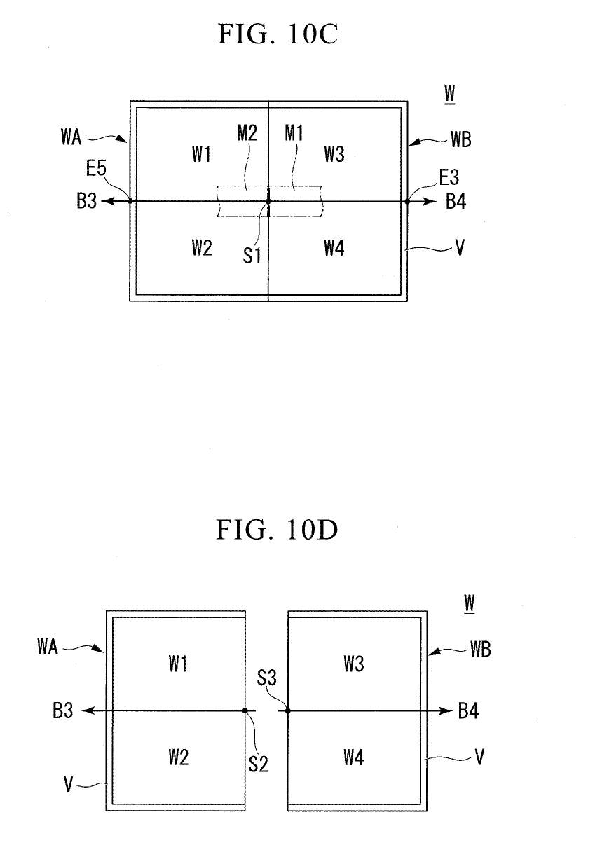

FIGS. 10A to 10D are plan views of the workpiece W showing a cutting procedure when one workpiece W is cut into four small pieces W1 to W4. The workpiece W is tempered glass having end sections at which chamfering V is formed.

First, a cutting manipulation is performed with respect to the workpiece W along a line shown by an arrow B1 of FIG. 10A. In this case, at a termination point (E1 of FIG. 10A) of the cutting manipulation, the reinforcement layer L1 of the workpiece W is thinned by the chamfering V. For this reason, after termination of the cutting manipulation, the workpiece W is automatically cut along a line B1 from the termination point E1 toward the starting point, and small pieces WA and WB are obtained.

Next, the cutting manipulation is performed with respect to the small pieces WA and WB along the line shown by an arrow B2 of FIG. 10A. In this case, in the termination point of the cutting manipulation with respect to the small piece WA (E2 of FIG. 10A), the reinforcement layer L1 is not thinned. For this reason, before the cutting manipulation, in the termination point E2, there is a need to form an initial crevice C1 on the surface of the small piece WA along a line B2. Meanwhile, since the chamfering V is formed at the termination point (E3 of FIG. 1 OA) of the cutting manipulation with respect to the small piece WB, when the cutting manipulation with respect to the small piece WB is performed, there is no need to form the initial crevice.

After forming the initial crevice at the termination point E2, as the cutting manipulation is performed along the line B2, after termination of the cutting manipulation, the small pieces WA and WB are automatically cut along the line B2 from the termination points E2 and E3 toward the starting point, and the small pieces W1 to W4 are obtained.

Further, instead of formation of the initial crevice at the termination point E2 of the small piece WA, as shown in FIG. 10B, after horizontally inverting the small piece WA 180 degrees from the position shown in FIG. 1 OA, the cutting manipulation may be performed along the line B2. In this case, since the chamfering V is formed at the termination point (E4 of FIG. 10B) of the cutting manipulation with respect to the small piece WA, even when the cutting manipulation with respect to the small piece WA is performed, there is no need to form the initial crevice.

Alternatively, as shown in FIG. 10C, after cutting of the workpiece W along the line B1, the cutting manipulation may be performed along lines B3 and B4 perpendicular to the line B1 using a point S1 on the cutting surfaces of the obtained small pieces WA and WB as a starting point. Even in this case, since the chamfering V is formed at all the termination points (E5 and E3 of FIG. 10C) of the cutting manipulation with respect to the small pieces WA and WB, there is no need to form the initial crevice before the cutting manipulation.

However, when the cutting manipulation of the small piece WA is performed along the line B3 from the point S1, the small piece WB side of the point S1 may be covered with a mask M1 from above such that the laser beam is not radiated thereto. Similarly, when the cutting manipulation of the small piece WB is performed along the line B4 from the point S1, the small piece WA side of the point S1 may be covered with a mask M2 from above such that the laser beam is not radiated thereto. These are because, when the cutting manipulation is performed two times along the lines B3 and B4 using the same point S1 as the starting point, inconvenience due to excessive radiation of the laser beam to the small pieces WA and WB in the vicinity of the point S1 is avoided.

Alternatively, as shown in FIG. 10D, the small pieces WA and WB may be previously separated, and the cutting manipulation may be performed along the lines B3 and B4 perpendicular to the line B1 using points S2 and S3 on the cutting surfaces of the small pieces WA and WB as starting points. Even in this case, like FIG. 10C, there is no need to form the initial crevice before the cutting manipulation. In addition, since the small pieces WA and WB are separated, the cutting manipulation along the lines B3 and B4 is performed using the separated points S2 and S3 as the starting points. Accordingly, when the cutting manipulation along the lines B3 and B4 is performed, the masks M1 and M2 are not needed.

In addition, in the present embodiment, in the process of heating and cooling the surface of the reinforcement layer L1, the workpiece W is linearly heated and cooled from the starting position to the termination position. According to the above-mentioned configuration, since the crevice in the reinforcement layer L1 linearly progresses, the reinforcement layer L1 can be easily finely cut along the cutting surface of the non-reinforcement layer L2, and deterioration of quality of the workpiece W can be suppressed.

In addition, as described above, in the present embodiment, since the workpiece W can be cut without forming a scribed groove or the like through pre-processing and without bending through post-processing, a tact time can be reduced and the processing can be rapidly performed. Furthermore, no trajectory of the groove is generated in the cutting surface and no crack is generated through pre-processing. For this reason, deterioration of quality of the workpiece can be suppressed.

In addition, since the workpiece W is instantly cut when the heating processing and the cooling processing are terminated, if a holding force of the workpiece W is deviated, the stress applied to the workpiece W is deviated, and the crevice may progress in an unintentional direction. In the present embodiment, as described above, since the workpiece W is supported by a uniform pressure from the back surface of the workpiece W, the crevice can progress in a desired direction to cut the workpiece W.

In the above-mentioned embodiment, while the case in which the laser radiation unit 4 is used as the heating unit has been described. However, the heating unit may continuously heat the surface of the reinforcement layer L1 in the surface direction and transmit heat to the reinforcement layer L1 and the non-reinforcement layer L2, and may be, for example, a gas burner or the like.

In addition, while the case in which the laser radiation unit 4 uses the carbon dioxide gas as the medium has been described. However, as long as the surface of the reinforcement layer L1 of the workpiece W can be heated, another medium may be used. For example, a pulse laser or the like having permeability with respect to the workpiece W (glass) can also be used at a shorter wavelength.

In addition, in the process of heating the surface of the reinforcement layer L1, while the case in which the laser beam is radiated a plurality of times to the same place of the surface of the reinforcement layer L1, and a laser beam radiated earlier has higher energy per unit area upon arrival at the surface of the reinforcement layer L1 than a laser beam radiated later has been described. However, this is not a necessary configuration. That is, the radiation region of the laser beam may not be singular, and the plurality of radiation regions may have the same energy.

In addition, before the process of heating the surface of the reinforcement layer L1, while the case in which the workpiece W is supported by a uniform pressure from the back surface of the workpiece W has been described. However, in the surface of the reinforcement layer L1 of the workpiece W, a region other than the radiation region of the laser beam may be supported, or a supporting pressure may be non-uniform.

In addition, in the above-mentioned embodiment, while the case in which the porous chuck 3 is used as the means configured to support the workpiece W with the uniform pressure from the back surface of the workpiece W has been described. However, this means is not limited to the porous chuck 3 but, for example, an adhesive tape may be attached to an opposite back surface of the surface of the workpiece W to which the laser beam is radiated to support the workpiece W. In this case, the adhesive tape may be attached to the entire back surface of the workpiece W or may be attached to a plurality of places at intervals.

Hereinabove, while exemplary embodiments of the present invention have been described with reference to the accompanying drawings, it is needless to say that the present invention is not limited to the above-mentioned embodiments. It will be apparent to those skilled in the art that various modifications or amendments may be made without departing from the scope of the claims, and these will fall into the technical spirit of the present invention.

### INDUSTRIAL APPLICABILITY

The present invention can be used in a workpiece cutting method and a workpiece cutting apparatus capable of cutting a workpiece using thermal stress.

### REFERENCE SIGNS LIST

L1 reinforcement layer
L2 non-reinforcement layer
W workpiece
1 workpiece cutting apparatus
4 laser radiation unit (heating unit)
6 injection unit (cooling unit)

1. A workpiece cutting method of cutting a workpiece in which a reinforcement layer to which compression stress is applied is stacked on a surface of a non-reinforcement layer in a thickness direction of the workpiece, the workpiece cutting method comprising:
a process of continuously heating the surface of the reinforcement layer in a direction perpendicular to the thickness direction and transferring heat to the reinforcement layer and the non-reinforcement layer; and
a process of injecting a cooling medium to a surface of the workpiece after heating, and generating thermal stress equal to or larger than breaking stress of the non-reinforcement layer in a boundary portion of the non-reinforcement layer with respect to the reinforcement layer.

2. A workpiece cutting method of cutting a workpiece in which a reinforcement layer to which compression stress is applied is stacked on a surface of a non-reinforcement layer in a thickness direction of the workpiece, the workpiece cutting method comprising:
a process of continuously heating the surface of the reinforcement layer in a direction perpendicular to the thickness direction and transferring heat to the reinforcement layer and the non-reinforcement layer; and
a process of injecting a cooling medium to a surface of the workpiece after heating, and generating a crevice in the thickness direction in a boundary portion of the non-reinforcement layer with respect to the reinforcement layer.

3. A workpiece cutting method of cutting a workpiece in which a reinforcement layer to which compression stress is applied is stacked on a surface of a non-reinforcement layer in a thickness direction of the workpiece, the workpiece cutting method comprising:
a process of continuously heating the surface of the reinforcement layer in a direction perpendicular to the thickness direction and transferring heat to the reinforcement layer and the non-reinforcement layer;
a process of injecting a cooling medium to a surface of the workpiece after heating; and
a process of generating a crevice in the workpiece from a termination position to a starting position of the process of heating the surface of the reinforcement layer and the process of injecting the cooling medium to the surface of the workpiece after heating after termination of these processes.

4. The workpiece cutting method according to any one of claim 1, wherein, in the process of heating the surface of the reinforcement layer, the starting position and the termination position of the heating processing become boundaries between the surface and a side surface of the workpiece.

5. The workpiece cutting method according to claim 4, wherein, in the process of heating the surface of the reinforcement layer, the workpiece is linearly heated from the starting position to the termination position.

6. The workpiece cutting method according to any one of claim 1, wherein, in the process of heating the surface of the reinforcement layer, a laser beam is radiated to heat the surface.

7. The workpiece cutting method according to claim 6, wherein the laser beam is generated using carbon dioxide gas as a medium.

8. The workpiece cutting method according to claim 6, wherein, in the process of heating the surface of the reinforcement layer, the laser beam is radiated a plurality of times to the same place of the surface of the workpiece, and the laser beam radiated earlier has higher energy per unit area upon arrival at the surface of the workpiece than the laser beam radiated later.

9. The workpiece cutting method according to any one of claim 1, further comprising a process of supporting the workpiece with a uniform pressure from a back surface of the workpiece, before the process of heating the surface of the reinforcement layer.

10. A workpiece cutting apparatus for cutting a workpiece in which a reinforcement layer to which compression stress is applied is stacked on a surface of a non-reinforcement layer in a thickness direction of the workpiece, the workpiece cutting apparatus comprising:
a heating unit configured to continuously heat the surface of the reinforcement layer in a direction perpendicular to the thickness direction and transfer heat to the reinforcement layer and the non-reinforcement layer; and
a cooling unit configured to inject a cooling medium to a surface of the workpiece after heating, and generate thermal stress equal to or larger than breaking stress of the non-reinforcement layer in a boundary portion of the non-reinforcement layer with respect to the reinforcement layer.

11. A workpiece cutting apparatus for cutting a workpiece in which a reinforcement layer to which compression stress is applied is stacked on a surface of a non-reinforcement layer in a thickness direction of the workpiece, the workpiece cutting apparatus comprising:
a heating unit configured to continuously heat the surface of the reinforcement layer in a direction perpendicular to the thickness direction and transfer heat to the reinforcement layer and the non-reinforcement layer; and
a cooling unit configured to inject a cooling medium to a surface of the workpiece after heating,
wherein termination positions of the heating in the heating unit and the cooling in the cooling unit are determined to generate a crevice in the workpiece after termination of the heating and the cooling from the termination position toward starting positions of the heating and the cooling.
